(19) United States
(12) Patent Application Publication
(10) Pub. No.: US 2022/0232480 A1
(43) Pub. Date: Jul. 21, 2022

(54) Transmit Power Allocation Technique

(71) Applicant: Telefonaktiebolaget LM Ericsson (publ), Stockholm (SE)

(72) Inventors: Zhipeng Lin, Nanjing (CN); Yufei Blankenship, Kildeer, IL (US); Robert Mark Harrison, Grapevine, TX (US)

(21) Appl. No.: 17/608,043

(22) PCT Filed: Apr. 28, 2020
(86) PCT No.: PCT/SE2020/050427

§ 371 Date: Nov. 1, 2021

Related U.S. Application Data
(60) Provisional application No. 62/842,392, filed on May 2, 2019.

(51) Int. Cl. H04W 52/14; H04W 52/36; H04W 74/08; H04W 52/28

(52) U.S. Cl. CPC H04W 52/146; H04W 52/281; H04W 74/0833; H04W 52/367

(57) ABSTRACT

A technique for allocating transmit power for uplink, UL, radio transmission is described. As to a method aspect, a method of allocating transmit power for at least two UL transmissions on one or more cells (302, 304) of a radio access network, RAN, is provided. The method comprises or initiates the step of allocating (202) the transmit power for the UL transmissions. A total transmit power resulting from the allocation is less than or equal to a maximum transmit power by allocating the transmit power to the UL transmissions according to a priority order of the UL transmissions. At least one UL transmission of a low-latency communication is prioritized over at least one UL transmission of a regular communication according to the priority order.

### TECHNICAL FIELD

The present disclosure relates to allocating transmit power for uplink radio transmissions. More specifically, and without limitation, methods and devices for allocating transmit power for at least two uplink transmissions on one or more cells of a radio access network are provided.

### BACKGROUND

Ultra-reliable and low-latency communication (URLLC) is one of the main use cases of 5G new radio (NR), e.g., a specified by the Third Generation Partnership Project (3GPP). The URLLC use cases include services for latency-sensitive devices and for applications such as factory automation, electrical power distribution, and remote driving. URLLC has strict requirements on transmission reliability and latency, for example, 99.9999% reliability within 1 ms one-way latency. In NR Release 15, 3GPP introduced several additional features and enhancements to support these requirements. In NR Release 16, the standardization works at 3GPP are focused on further enhancing URLLC system performance as well as ensuring reliable and efficient coexistent of URLLC and other NR use cases.

A typical radio device (also: user equipment or UE) implementing NR (i.e., a NR device) for the Internet of Things (IoT, particularly Industrial IoT or IIoT) would handle communication for multiple service types, e.g. periodic URLLC type robot control messages, URLLC type of occasional alarm signals (e.g., for which periodic resources would need to be configured), occasional sensor data transmission, other Mobile Broadband (MBB) type traffic such as occasional video transmissions or software updates. Hence, a traffic mix is to be multiplexed by the radio device for uplink (UL) transmissions. E.g., on a Medium Access Control (MAC) layer of the uplink, multiple logical channels with different priorities would need to be configured.

For connecting to a radio access network (RAN), the radio device has to perform a random access (RA) procedure, which conventionally comprise 4 steps (or 4 corresponding messages). In order to further reduce the latency in the uplink, a 2-step RA procedure has been proposed in the 3GPP document R1-1700703. A work item for the 2-step RA procedure (also referred to as 2-step RA channel or 2-step RACH) in NR has been proposed in the 3GPP document RP-182894.

When a mix of traffic is simultaneously present in the uplink, URLLC type of traffic needs to be treated with higher priority. For example, according to an inter-UE prioritization, the URLLC transmission of the UE may be prioritized over an enhanced Mobile Broadband (eMBB) transmission of the UE, e.g., as is defined in 3GPP Release 16 for NR. Furthermore, an intra-UE prioritization and/or multiplexing is also defined in 3GPP Release 16 for NR, wherein the URLLC transmission can pre-empt the eMBB transmission of the same UE.

The above measures for the control and data channels after establishing a radio resource control (RRC) connection support low-latency traffic (e.g., URLLC). However, loss of uplink messages and colliding uplink messages can increase latency, since the mix of traffic can lead to a suboptimal allocation of transmit power, particularly during the RA procedure.

### SUMMARY

Accordingly, there is a need for a transmit power allocation technique that reduces or optimizes latency in at least some situations.

As to a method aspect, a method of allocating transmit power for at least two uplink (UL) transmissions on one or more cells of a radio access network (RAN) is provided. The method comprises or initiates a step of allocating the transmit power for the UL transmissions. A total transmit power resulting from the allocation is less than or equal to a maximum transmit power by allocating the transmit power to the UL transmissions according to a priority order of the UL transmissions. At least one UL transmission of a low-latency communication is prioritized over at least one UL transmission of a regular communication according to the priority order.

The method aspect may further comprise any step or any feature disclosed below and/or the detailed description.

The method may be performed by a radio device, e.g., configured for radio access to the RAN. The low-latency communication and the regular communication may involve the same radio device, e.g., simultaneously.

At least some embodiments can reduce latency and/or increase reliability of the UL transmissions by allocating the transmit power to channels for prioritized UL (e.g., data) transmissions. More specifically, the transmit power may be allocated according to the priority order that considers different use cases and/or different channels together.

Same or further embodiments may determine the priority of power reductions with respect to the channels used in a 2-step Random Access (RA) procedure and/or the channels of an ultra-reliable low-latency communication (URLLC). For example, an URLLC channel and a UL channel used in 2-step RA can be considered properly together with existing channels, e.g., used in 3GPP NR Release 15.

The technique may be implemented for at least one of a URLLC, a 4-step RA procedure, a 2-step RA procedure (e.g., according to 3GPP NR Release 16) and a power reduction priority (e.g., according to 3GPP NR Release 15). More specifically, the UL transmission may be performed applying the respectively allocated transmit power in the RA procedure (e.g., in a physical random access control channel, PRACH, occasion) and/or in the UL transmission of a Message A (msgA) of the 2-step RA procedure or a Message 1 (msg1) or Message 3 (msg3) of the 4-step RA procedure.

Alternatively or in addition, parameters of the method, e.g., the maximum transmit power may be preconfigured and/or configured based on a system information broadcasted by the RAN.

A latency requirement of the low-latency communication may be more restrictive than a latency requirement of the regular communication.

The low-latency communication may comprise a 2-step RA procedure on a primary cell (PCell).

The UL transmission of the 2-step RA procedure may comprise at least one of the UL transmission of a RA preamble (i.e., the UL transmission of the preamble part) and the UL transmission on a physical uplink shared channel (PUSCH, i.e., the UL transmission of the PUSCH part).

The UL transmission of the 2-step RA procedure may also be referred to as “message A” or “msgA” transmission. The msgA may comprise at least one of the RA preamble of the 2-step RA procedure (i.e., the preamble part) and an UL message of the 2-step RA procedure on the PUSCH (i.e., the PUSCH part of msgA). The UL transmission of the msgA may correspond to the first step out of the two steps of the 2-step RA procedure.

The at least one UL transmission of the low-latency communication may comprise the UL transmission of a RA preamble in a 2-step RA procedure on a PCell.

The at least one UL transmission of the low-latency communication may comprise the UL transmission on a physical uplink shared channel, PUSCH, in a 2-step RA procedure on a PCell.

The UL transmission on the PUSCH in the 2-step RA procedure on the PCell may be prioritized according to the priority order over at least one of the UL transmission of the RA preamble in the 2-step RA procedure on the PCell and the UL transmission of a RA preamble in a 4-step RA procedure on the PCell.

Alternatively, at least one of the UL transmission of the RA preamble in the 2-step RA procedure on the PCell and the UL transmission of a RA preamble in a 4-step RA procedure on the PCell may be prioritized according to the priority order over the UL transmission on the PUSCH in the 2-step RA procedure on the PCell.

The UL transmission of the RA preamble in the 2-step RA procedure on the PCell and the UL transmission of a RA preamble in the 4-step RA procedure on the PCell may have the same priority (i.e., may be equally prioritized) according to the priority order.

The RA preamble of the 4-step RA procedure may also be referred to as “message 1” or “msg1”. The UL transmission of the msg1 may correspond to the first step out of the four steps of the 4-step RA procedure.

The UL transmission of a RA preamble in a 4-step RA procedure on the PCell and the UL transmission of the RA preamble in the 2-step RA procedure on the PCell may have the same priority according to the priority order.

Alternatively, the UL transmission of a RA preamble in a 4-step RA procedure on the PCell may be prioritized according to the priority order over the UL transmission in the 2-step RA procedure on the PCell.

Furthermore, the UL transmission of the RA preamble in the 2-step RA procedure on the PCell may be prioritized according to the priority order over the UL transmission of the RA preamble in the 4-step RA procedure on the PCell.

Alternatively or in addition, the UL transmission in the 2-step RA procedure on the PCell may be prioritized according to the priority order over the UL transmission in the 2-step RA procedure on a serving cell other than the PCell.

The regular communication may comprise a 2-step RA procedure on a serving cell other than the PCell.

The at least one UL transmission of the regular communication may comprise the UL transmission of a RA preamble in a 2-step RA procedure on a serving cell other than the PCell.

The at least one UL transmission of the regular communication may comprise the UL transmission on a PUSCH in a 2-step RA procedure on a serving cell other than the PCell.

The PUSCH part of the 2-stepf RA procedure for the PCell and other serving cells may have the same priority as normal PUSCH.

The at least one UL transmission of the regular communication may comprises the UL transmission on a physical uplink control channel (PUCCH).

The UL transmission on the PUCCH may comprise a PUCCH transmission with channel state information (CSI).

Alternatively or in addition, the UL transmission of the regular communication may comprise the UL transmission of a control message on the PUSCH. For example, the regular communication may comprise the UL transmission of CSI or hybrid automatic repeat request (HARQ) acknowledgment (ACK) information on the PUSCH.

The at least one UL transmission of the regular communication may comprise the UL transmission of payload on a PUSCH without a control message. The at least one UL transmission of the regular communication may optionally further comprise the UL transmission on the PUSCH in the 2-step RA procedure on the PCell or any serving cell.

The UL transmission of payload on the PUSCH without a control message may comprise a PUSCH transmission without HARQ-ACK information and/or without CSI.

The UL transmission of payload on the PUSCH without a control message and the UL transmission on the PUSCH in the 2-step RA procedure (e.g., on the PCell or on any serving cell) may have the same priority (i.e., may be equally prioritized) according to the priority order.

The at least one UL transmission of the regular communication may comprise the UL transmission of a sounding reference signal (SRS).

The at least one UL transmission of the regular communication may comprise the UL transmission of a RA preamble in a 4-step RA procedure on a serving cell other than the PCell.

At least two of the UL transmission of the SRS, the UL transmission of the RA preamble in the 4-step RA procedure on the serving cell other than the PCell, and the UL transmission of the RA preamble in the 2-step RA procedure on the serving cell other than the PCell may have the same priority according to the priority order.

At least one of the UL transmission on the PUCCH, the UL transmission of payload on the PUSCH without a control message, the UL transmission of the SRS, and the UL transmission of the RA preamble in the 4-step RA procedure on the serving cell other than the PCell may be prioritized according to the priority order over the UL transmission in the 2-step RA procedure on the serving cell other than the PCell.

The at least one UL transmission of the low-latency communication may comprise an initial transmission on a PUSCH in a 2-step RA procedure on the PCell. The at least one UL transmission of the regular communication may comprise a retransmission on the PUSCH in the 2-step RA procedure on the PCell.

The PUSCH part of the 2-step RA procedure for the initial transmission may have a higher priority than at least one of PUCCH and/or PUSCH and/or SRS. A retransmission of the PUSCH part of the 2-step RA procedure may have the same priority as normal PUSCH.

The low-latency communication may comprise an ultra-reliable low-latency communication (URLLC) on the one or more cells.

The low-latency communication may further comprise the RA preamble in the 4-step RA procedure on the PCell.

The at least one UL transmission of the URLLC may comprise at least one of an UL transmission on a PUCCH, an UL transmission of a control message on a PUSCH, and an UL transmission of payload on the PUSCH without a control message.

The at least one UL transmission of the URLLC may comprise at least one of an UL transmission in a 2-step RA procedure on a serving cell other than the PCell and an UL transmission of a RA preamble in a 4-step RA procedure on a serving cell other than the PCell.

The at least one UL transmission of the RA preamble of the URLLC may be prioritized according to the priority order over the at least one UL transmission on the PUCCH and/or the PUSCH of the URLLC.

At least one of the UL transmission in the 2-step RA procedure on the PCell and the UL transmission of a RA preamble in a 4-step RA procedure on the PCell may be prioritized according to the priority order over at least one of the UL transmission, e.g. of the RA preamble, in the 2-step RA procedure of the URLLC and the UL transmission of the RA preamble in the 4-step RA procedure of the URLLC.

The method may be performed by a radio device (e.g., a user equipment, UE). The radio device may be configured to wirelessly connect to the one or more cells of the RAN. The RAN may be configured to provide radio access (i.e., the wireless connection) to the radio device.

Herein, the UL transmissions may encompass any transmission from the radio device to one or more cells of the RAN. The transmit power may be allocated so that the total transmit power is smaller than or equal to the maximum transmit power in every symbol of transmission occasion.

The RA preamble in the 4-step RA procedure may be transmitted in a RA channel (RACH).

Herein, a first UL transmission may be “prioritized over” a second UL transmission if (e.g., only if) a priority of the first UL transmission is higher than the priority of the second UL transmission according to the priority order. Occasionally, the expression “priority order” may be used in the sense of a priority according to the priority order.

The priority order may be defined as a list of UL transmissions, e.g., a list in descending order of the priority.

The transmit power may also be referred to as an output power. For example, the total transmit power and/or the maximum transmit power may also be referred to as the total output power and the maximum output power, respectively.

The at least two UL transmissions may comprise at least one of a PUSCH transmission, a PUCCH transmission, a RA preamble transmission, a PRACH transmission and a SRS transmission.

The at least two UL transmissions may use at least two UL carriers on one cell of the RAN.

The at least two UL transmissions may use at least two UL carriers, respectively, on the one cell of the RAN. The technique may be implemented for a single cell operation with two UL carriers.

The at least two UL transmissions may use at least two serving cells of the RAN.

The technique may be implemented for an operation with multi-connectivity, e.g., dual connectivity (DC), or carrier aggregation (CA). The at least two UL transmissions may use at least two serving cells of the RAN.

The total transmit power resulting from the allocation may be less than or equal to the maximum transmit power by allocating a second transmit power to at least one of the UL transmissions having a second priority. The second transmit power may be reduced relative to a predefined transmit power or a first transmit power allocated to another one of the UL transmissions having a first priority that is higher than the second priority according to the priority order.

The method aspect may further comprise or initiate the step of determining the total transmit power in a symbol of a transmission occasion. The allocation may comprise reducing the second transmit power if the determined total transmit power would exceed the maximum transmit power.

For example, the second transmit power may be reduced relative to the predefined transmit power if the total transmit power determined based on the predefined transmit power would exceed the total transmit power.

The total transmit power may be determined preemptively and/or prior to performing the UL transmissions.

The determined total transmit power in the symbol of the transmission occasion need not, or may not, include power for transmissions starting after the symbol of the transmission occasion.

The method aspect may further comprise or initiate the step of performing the UL transmissions using the respectively allocated transmit power.

For example, the UL transmissions may comprise performing the RA procedure to the cell or each of the cells of the RAN.

The UL transmissions may be performed simultaneously.

The UL transmissions may at least partially overlap in the time domain. The UL transmission(s) may be performed in a single transmission occasion.

The total transmit power resulting from the allocation may be less than or equal to the maximum transmit power in each symbol of a transmission occasion.

The method may be performed by a radio device configured to wirelessly connect to one or more cells of the RAN. The total transmit power and the maximum transmit power may be determined or configured per radio device.

The total transmit power may be the total transmit power of the radio device. The maximum transmit power may be the maximum transmit power for the radio device.

The maximum transmit power may be a linear value of a maximum output power in a transmission occasion. The total transmit power in each symbol of the transmission occasion may be the sum of the linear values of the transmit powers allocated to the UL transmissions in the respective symbol.

The maximum transmit power may be the linear value of the maximum output power configured for the radio device in the transmission occasion.

The total transmit power in a symbol of a slot (e.g., in each symbol of a transmission occasion) may be defined as the sum of the linear values of the transmit powers allocated for PUSCH, PUCCH, PRACH, and SRS in the symbol of the slot. In an operation with carrier aggregation (CA), the transmit power may be allocated for at least two serving cells of the RAN, e.g., one serving cell for each component carrier of the CA. A coverage of each of the serving cells may differ, e.g., due to different frequencies of the component carriers. A radio resource control (RRC) connection may be handled by one of the serving cells, which may be referred to as the Primary serving cell (PSCell), served by a Primary component carrier (e.g., DL and UL PCC). The other component carriers (CCs) may all be referred to as Secondary component carrier (e.g., DL and possibly UL SCC), serving Secondary serving cells (SSCells).

In an operation with dual connectivity (DC), base stations (e.g., eNBs or gNBs) involved in the DC may assume two different roles for the radio device (e.g., UE). A base station may either acts as a Master base station or as a Secondary base station. A Master Cell Group (MCG) and a Secondary Cell Group (SCG) may be defined as a group of serving cells associated with the Master and Secondary base stations, respectively, e.g., comprising the Primary Cell and a Primary SCell, respectively, and optionally of one or more Secondary Cells (SCells). The Primary Cell and the Primary SCell may be examples of the aforementioned PCell. In the operation with DC, the radio device may be connected to one Master base station and one Secondary base station. The radio device may operate two Medium Access Control (MAC) entities and/or two separate Radio Link Control (RLC) entities for each data flow on each of the Master base station and the Secondary base station.

A transmission occasion/on PUSCH, PUCCH, SRS or PRACH may be defined by a slot index n_{s,f}^{u} within a frame with system frame number SFN, a first symbol S within the slot, and a number of consecutive symbols L.

The radio device (e.g., UE) may be allowed to reduce the maximum output power due to higher order modulations and transmit bandwidth configurations. For UE Power Class 2 and 3, the allowed maximum power reduction (MPR) may be defined in Table 6.2.2-2 and Table 6.2.2-1, respectively, of the 3GPP document TS 38.101-1, version 15.5.0, in section 6.2.2.

Additional emission requirements may be signaled by the RAN. Each additional emission requirement may be associated with a unique network signaling (NS) value indicated in RRC signaling by an NR frequency band number of the applicable operating band and an associated value in a field AdditionalSpectrumEmission, e.g., as defined in the 3GPP document TS 38.101-1, version 15.5.0, section 6.2.3.1.

Alternatively or in addition, the radio device (e.g., UE) may configure its maximum total output power, P_{CMAX}, for CA, e.g., according to section 6.2A.4 of the 3GPP document TS 38.101-2, version 15.5.0. P_{CMAX} may be defined as that available to the reference point of a given transmitter branch that corresponds to the reference point of the higher-layer filtered reference signal received power (RSRP) measurement, e.g., as specified in the 3GPP document TS 38.215, version 15.5.0.

The technique may be implemented as a method on power reduction priority in NR technique.

The allocation and/or the UL transmissions may be performed by a radio device. The method aspect may be performed at or by the radio device. The UL transmissions from the radio device may be received by one or more base stations of the RAN.

The one or more base stations may form, or may be part of, the RAN, e.g., according to the Third Generation Partnership Project (3GPP) or according to the standard family IEEE 802.11 (Wi-Fi). The RAN may comprise one or more base stations. Each base station may provide radio access to the radio device in at least one cell of the one or more cells.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Any of the radio devices may be wirelessly connected or connectable (e.g., according to a radio resource control, RRC, state or active mode) with any of the base stations.

Herein, a base station may encompass any station that is configured to provide radio access to the radio device. The base stations may also be referred to as transmission and reception point (TRP), radio access node or access point (AP). The base station or one of the radio devices functioning as a gateway (e.g., between the radio network and the RAN and/or the Internet) may provide a data link to a host computer providing user data. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical Layer (PHY), a Medium Access Control (MAC) layer, a Radio Link Control (RLC) layer and/or a Radio Resource Control (RRC) layer of a protocol stack for the radio communication.

As to another aspect, a computer program product is provided. The computer program product comprises program code portions for performing any one of the steps of the method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a device aspect, a device for allocating transmit power for at least two uplink (UL) transmissions on one or more cells of a radio access network (RAN) is provided. The device is configured to perform any one of the steps of the method aspect.

As to a further device aspect, a device for allocating transmit power for at least two uplink (UL) transmissions on one or more cells of a radio access network (RAN) is provided. The device comprises at least one processor and a memory. Said memory comprises instructions executable by said at least one processor whereby the device is operative to perform any one of the steps of the method aspect.

As to a still further device aspect, a device is provided, which comprises memory operable to store instructions and processing circuitry operable to execute the instructions, such that the device is operable to perform any of the steps of the method aspect.

As to a still further device aspect, a UE configured to communicate with a base station is provided, the UE comprising a radio interface and processing circuitry configured to execute any of the steps of the method aspect.

As to a still further aspect a communication system including a host computer is provided. The host computer comprises a processing circuitry configured to provide user data, e.g., triggering at least one of the UL transmissions. The host computer further comprises a communication interface configured to forward the user data to a cellular network (e.g., the RAN and/or the one or more base stations) for transmission to the radio device (e.g., a UE). A processing circuitry of the cellular network may be configured to execute any step for configuring the UE to perform the method and/or for receiving the UL transmissions. The UE comprises a radio interface and processing circuitry, which is configured to execute any one of the steps of the method aspect.

The communication system may further include the UE. Alternatively, or in addition, the cellular network may further include one or more base stations configured for radio communication with the UE and/or to provide a data link between the UE and the host computer using the method aspect.

The processing circuitry of the host computer may be configured to execute a host application, thereby providing the user data and/or any host computer functionality described herein. Alternatively or in addition, the processing circuitry of the UE may be configured to execute a client application associated with the host application.

As to a still further aspect, a method implemented in a UE comprising any one of the steps of the method aspect is provided.

Any one of the devices, the radio device (e.g., the UE), the one or more base stations, the communication system or any node or station for embodying the technique may further include any feature disclosed in the context of the method aspect, and vice versa. Particularly, any one of the units and modules disclosed herein may be configured to perform or initiate one or more of the steps of the method aspect.

### BRIEF DESCRIPTION OF THE DRAWINGS

Further details of embodiments of the technique are described with reference to the enclosed drawings, wherein:

FIG. 1 shows a schematic block diagram of an embodiment of a device for allocating transmit power;

FIG. 2 shows a flowchart for an embodiment of a method of allocating transmit power, which method may be implementable by the device of FIG. 1;

FIG. 3 schematically illustrates an exemplary signaling diagram for a random access procedure comprising 4 steps or 4 messages;

FIG. 4 schematically illustrates an exemplary signaling diagram for a random access procedure comprising 2 steps or 2 messages;

FIG. 5 shows a schematic block diagram of an embodiment of a radio device embodying the device of FIG. 1 or implementing the method of FIG. 2;

FIG. 6 schematically illustrates an example telecommunication network connected via an intermediate network to a host computer;

FIG. 7 shows a generalized block diagram of an example host computer communicating via a base station or radio device functioning as a gateway with a user equipment over a partially wireless connection; and

FIGS. 8 and 9 show flowcharts for methods implemented in a communication system including a host computer, a base station or radio device functioning as a gateway and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

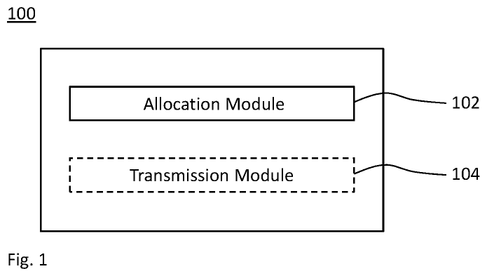

FIG. 1 schematically illustrates a block diagram of an embodiment of a device for allocating transmit power for at least two uplink (UL) transmissions on one or more cells of a radio access network (RAN). The device is generically referred to by reference sign 100.

The device 100 comprises an allocation module 102 that allocates the transmit power for the UL transmissions. A total transmit power resulting from the allocation is less than or equal to a maximum transmit power by allocating the transmit power to the UL transmissions according to a priority order of the UL transmissions. At least one UL transmission of a low-latency communication is prioritized according to the priority order over at least one UL transmission of regular communication.

Optionally, the device 100 further comprises a transmission module 104 that initiates or performs the UL transmissions using the respectively allocated transmit power for each of the at least two UL transmissions. For example, the at least two UL transmissions are performed by a radio device in the same transmission occasion.

Any of the modules of the device 100 may be implemented by units configured to provide the corresponding functionality.

The device 100 may also be referred to as the radio device, or may be embodied by the radio device. The radio device 100 and the RAN, e.g., at least one base station of the RAN, may be in direct radio communication.

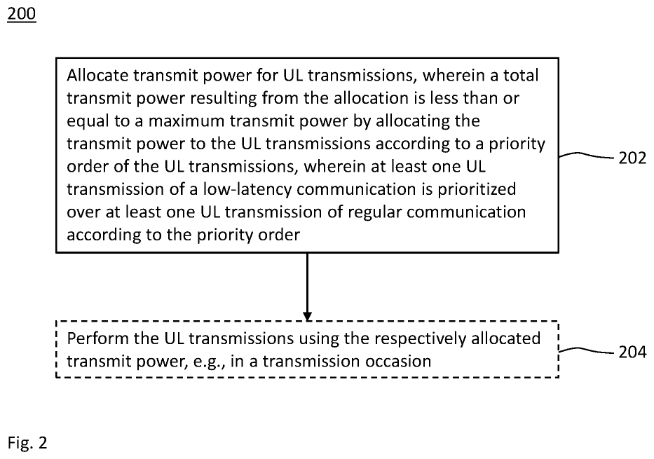

FIG. 2 shows an example flowchart for a method 200 of allocating transmit power for at least two UL transmissions on one or more cells of a RAN.

In a step 202, the transmit power for the UL transmissions is allocated. A total transmit power resulting from the allocation is less than or equal to a maximum transmit power by allocating the transmit power to the UL transmissions according to a priority order of the UL transmissions. At least one UL transmission of a low-latency communication is prioritized over at least one UL transmission of regular communication according to the priority order.

Optionally, in a step 204, the UL transmissions are performed using the transmit power allocated to each of the UL transmissions in the step 202.

The method 200 may be performed by the device 100. For example, the modules 102 and 104 may perform the steps 202 and 204, respectively.

In any aspect, the radio device 100 may be a mobile or portable station and/or any radio device wirelessly connectable to a base station or RAN, or to another radio device. For example, the radio device may be a user equipment (UE), a device for machine-type communication (MTC) or a device for (e.g., narrowband) Internet of Things (IoT). Two or more radio devices may be configured to wirelessly connect to each other, e.g., in an ad hoc radio network or via a 3GPP SL connection. Furthermore, any base station may be a station providing radio access, may be part of a radio access network (RAN) and/or may be a node connected to the RAN for controlling the radio access. For example, the base station may be an access point, for example a Wi-Fi access point.

The technique may be used for UL transmissions of a RA procedure, e.g., a 2-step RA procedure and/or a 4-step RA procedure.

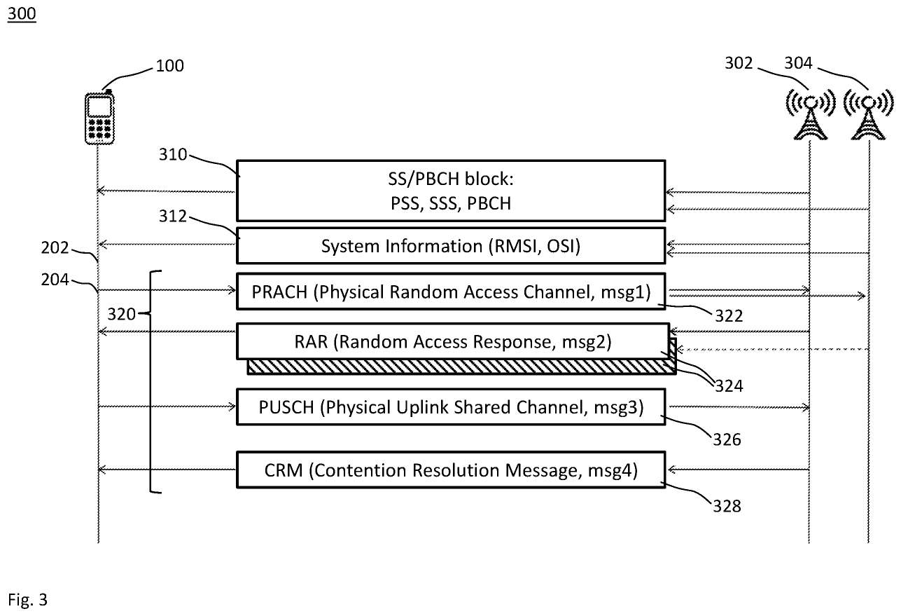

FIG. 3 schematically illustrates an exemplary signaling diagram for a 4-step RA procedure, i.e., a RA procedure comprising 4 steps or 4 messages, e.g., in a 3GPP NR implementation.

In the example, the one or more cells comprise two cells 302 and 304. While these cells are schematically illustrated by two base stations (e.g., gNBs), respectively, the cells 302 and 304 may also be served by one base station.

A 4-step approach is used for the RA procedure. In this approach, the UE 100 detects a synchronization signal (SS) 310 and decodes the broadcasted system information 312. The 4-step RA procedure 320 comprises transmitting a RA preamble 322 (also: RAP, PRACH preamble or message 1) in the uplink. Each of the gNB 302 and/or 304 replies with a RA response 324 (also: RAR or message 2). The UE 100 then transmits a UE identification 326 (message 3) on PUSCH.

The UE 100 transmits PUSCH (message 3) after receiving a timing advance (TA) command in the RAR 324, allowing PUSCH to be received with a timing accuracy within the cyclic prefix (CP). Without this timing advance, a very large CP would be needed in order to be able to demodulate and detect PUSCH, unless the system is applied in a cell with very small distance between UE 100 and gNB 302 and/or 304. Since NR also supports larger cells with a need for providing a timing advance to the UE 100, the 4-step approach is needed for the RA procedure in at least some situations.

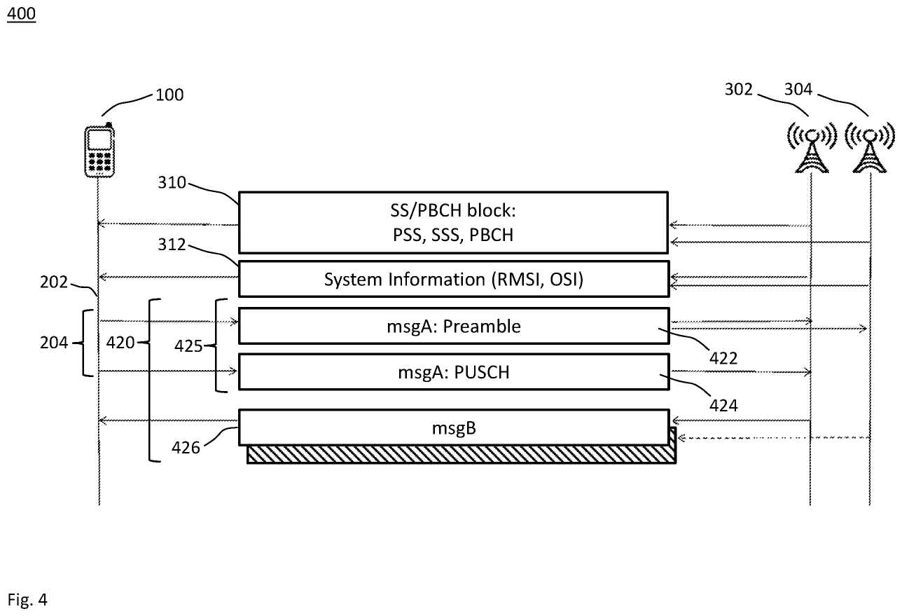

FIG. 4 schematically illustrates an exemplary signaling diagram for a 2-step RA procedure, i.e., a RA procedure comprising 2 steps or 2 messages. The 2-step RA may be compatible with, or may be modified to comply with, a 2-step RACH work item for Release 16 in 3GPP, e.g., with the 3GPP document RP-182894 (i.e., a 2-step RACH work item approved in RAN1 #82 plenary meeting).

As schematically illustrated in FIG. 4, an initial access is completed in only two steps. In the Step 1 of the 2-step RA procedure 420, the UE 100 transmits a “message A” 425 (or “msgA” in short) including a RA preamble 422 together with higher layer data 424, e.g., a RRC connection request and/or (e.g., with some small) payload on PUSCH. In the Step 2, the gNB 302 and/or 304 transmits a response message 426 (also referred to as “message B” or “msgB” in short) including at least one of UE identifier assignment, timing advance information, and contention resolution message etc.

A main purpose of the 2-step RA procedure is to reduce the time duration for a RA (which is also referred to as source of latency herein), so in some sense the msgA transmission 204 may need to be prioritized, especially for the msgA PUSCH part 424, which is weaker, e.g. in terms of transmit power, compared to the msgA preamble part 422 and has a possibility to collide with other msgA PUSCH transmissions on the same time frequency resource.

Embodiments of the method 200 may be implemented as an enhancement of a power reduction priority according to 3GPP NR Release 15. More specifically, the technique may be implemented based on and/or by extending section 7.5 of 3GPP document TS 38.213, version 15.5.0, as to the prioritizations of the transmission power reductions.

Any embodiment may be implemented for single cell operation with two uplink carriers or for operation with carrier aggregation. If a total UE transmit power for a PUSCH or PUCCH or PRACH or SRS transmission in a respective transmission occasion i would exceed \hat{P}_{CMAX}(i) where \hat{P}_{CMAX}(i) is the linear value of P_{CMAX}(i) in transmission occasion i as defined in the 3GPP document TS 38.101-1 and the 3GPP document TS 38.101-2, the UE 100 allocates power to at least one of PUSCH transmissions, PUCCH transmissions, PRACH transmissions, and SRS transmissions according to the following priority order (in descending order) so that the total UE transmit power is smaller than or equal to \hat{P}_{CMAX}(i) in every symbol of transmission occasion i. When determining a total transmit power in a symbol of transmission occasion i, the UE 100 does not include power for transmissions starting after the symbol of transmission occasion i. The total UE transmit power in a symbol of a slot is defined as the sum of the linear values of UE transmit powers for PUSCH, PUCCH, PRACH, and SRS in the symbol of the slot.

A basic priority order (in descending order), which may be extended according to the technique, reads:
PRACH transmission on the PCell;
PUCCH transmission with HARQ-ACK information and/or SR (e.g. Scheduling Request) or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or PRACH transmission on a serving cell other than the PCell.

In case of the same priority order and for operation with carrier aggregation, the UE 100 prioritizes power allocation for transmissions on the primary cell of the MCG or the SCG over transmissions on a secondary cell and prioritizes power allocation for transmissions on the PCell over transmissions on the PSCell. In case of the same priority order and for operation with two UL carriers, the UE 100 prioritizes power allocation for transmissions on the carrier where the UE is configured to transmit PUCCH. If PUCCH is not configured for any of the two UL carriers, the UE 100 prioritizes power allocation for transmissions on the non-supplementary UL carrier.

The technique may extend and/or modify the basic priority for prioritizations for transmission power reductions considering the 2-step RA procedure 420.

In a first embodiment for the 2-step RA procedure 420, the msgA 425 as a whole for 2-step RA procedure 420 is prioritized over the UL transmission of PRACH preamble 322 for the 4-step RA procedure 320.

Considering that the msgA PUSCH 424, which is not that reliable compared to the UL transmission of the preamble 422, may have the collision issue, the msgA 425 may be prioritized over PRACH transmission 322 on a PCell 302.

For the msgA 425 on a serving cell 304 other than PCell 302, the msgA 425 may have the same priority as the PRACH transmission 322 for the 4-step RA procedure 320. In the discussion below, PRACH transmission 322 of the 4-step RA procedure 320 is called msg1 PRACH 322, to differentiate from the preamble 422 of the 2-step RA procedure 420. In the discussion below, it is understood that the msgA 425 (and the corresponding UL transmission 204) is composed of two parts: (a) msgA preamble part 422 and (b) msgA PUSCH part 424.

Herein, exemplary modifications relative to the basic priority order are underlined.

So the priority order may be as below:
msgA transmission on the PCell;
msg1 PRACH transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or msg1 PRACH transmission on a serving cell other than the PCell, or msgA transmission on a serving cell other than the PCell.

In a second embodiment for the 2-step RA procedure 420, the msgA PUSCH part 424 and msgA preamble part 422 are prioritized separately with other channels.

In a first variant of the second embodiment of the method 200, the msgA PUSCH part 424 has a higher priority than the msgA preamble part 422, and the msgA preamble part 422 may have the same priority as the msg1 preamble 322 (i.e., PRACH) as they are both RA preambles (i.e., functionally almost the same).

So the priority order can be as below:
msgA PUSCH transmission on the PCell;
msg1 PRACH transmission on the PCell or msgA preamble transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or msg1 PRACH transmission on a serving cell other than the PCell, or msgA preamble and msgA PUSCH transmissions on a serving cell other than the PCell.

In a second variant of the second embodiment of the method 200, to make sure the 4-step RA procedure 320 is not affected by the 2-step RA procedure 420, the UL transmission 204 of the PRACH 322 for the 4-step RA procedure 320 may be prioritized over the PUSCH 424.

So the priority order may read as below:
msg1 PRACH transmission on the PCell or msgA preamble transmission on the PCell;
msgA PUSCH transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or PRACH transmission on a serving cell other than the PCell, or msgA preamble and msgA PUSCH transmissions on a serving cell other than the PCell.

Alternatively, in a third variant of the second embodiment of the method 200, the priority order is shown below to have msgA PUSCH 424 prioritized over msgA preamble 422:
msg1 PRACH transmission on the PCell;
msgA PUSCH transmission on the PCell;
msgA preamble transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or PRACH transmission on a serving cell other than the PCell, or msgA preamble and msgA PUSCH transmissions on a serving cell other than the PCell.

In a fourth variant of the second embodiment of the method 200, the msgA PUSCH part 424 is treated the same as a normal PUSCH, while the msgA preamble part 422 is treated with the same priority as msg1 PRACH 322 (i.e., the preamble 322 of RA procedure 320).

The prioritization (i.e., the priority order) from higher priority to lower priority may be:
msg1 PRACH transmission on the PCell or msgA preamble transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI, including msgA PUSCH transmission on the PCell;
SRS transmission, with aperiodic SRS having higher priority than semi-persistent and/or periodic SRS, or PRACH transmission on a serving cell other than the PCell, or msgA preamble and msgA PUSCH transmissions on a serving cell other than the PCell.

Alternatively, in a fifth variant of the second embodiment of the method 200, both msgA PUSCH part 424 for the PCell 302 and other serving cells 304 are treated the same, and having the same priority as normal PUSCH.

For example, the prioritization from higher priority to lower priority may be:
msg1 PRACH transmission on the PCell or msgA preamble transmission on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI, including msgA PUSCH transmission on any serving cell;
SRS transmission, with aperiodic SRS having higher priority than semi-persistent and/or periodic SRS, or PRACH transmission on a serving cell other than the PCell, or msgA preamble transmissions on a serving cell other than the PCell.

In a third embodiment of the method 200, the msgA PUSCH part 424 for an initial transmission, the msgA PUSCH part 424 for a retransmission, and msgA preamble part 422 are prioritized separately with other channels.

While in the previous embodiments, msgA PUSCH initial transmission and retransmission are not differentiated, in the third embodiment they are given different priorities. The third embodiment may be combined with the first and/or the second embodiment.

In one variant of the third embodiment of the method 200, the msgA PUSCH part 424 for the initial transmission has a higher priority than at least one of PUCCH, PUSCH, SRS, etc., but its retransmission has the same priority of normal PUSCH.

For example, the second variant of the second embodiment may be modified to arrive at the following priority order, e.g., considering different priority orders of the PUSCH initial transmission and retransmissions on the PCell:
msg1 PRACH transmission on the PCell or msgA preamble transmission on the PCell;
Initial transmission of msgA PUSCH on the PCell;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI, including retransmission of msgA PUSCH on the PCell;
SRS transmission, with aperiodic SRS having higher priority than semi-persistent and/or periodic SRS, or PRACH transmission on a serving cell other than the PCell, or msgA preamble and msgA PUSCH transmissions on a serving cell other than the PCell.

Other embodiments (e.g., the first embodiment and/or any of the variants of the second embodiment) may be similarly modified to give retransmission of msgA PUSCH 424 a different (e.g., lower) priority from the initial transmission of msgA PUSCH 424 on the PCell 302 and/or cells 304 other than PCell 304.

Alternatively or in addition to the embodiments for the 2-step RA procedure 420 or the 4-step RA procedure 320, the technique may be implemented to prioritizations for transmission power reductions considering URLLC.

In a first embodiment for the URLLC (e.g., because the URLLC may not be located on the PCell 302), it is reasonable to prioritize the msgA 422, 424 on the cell (e.g., 302 or 304) that carries the URLLC (i.e., high-priority data). Indeed, the technique may prioritize all signal and/or channel associated with the URLLC.

An exemplary priority order may read:
PRACH transmission on the PCell;
Transmission on the one or more cells that carry high-priority data:
   PRACH or MsgA transmission;
   PUCCH transmission with HARQ-ACK information and/or SR or PUSCH transmission with HARQ-ACK information, where the HARQ-ACK and/or SR is associated with high-priority data;
   PUSCH transmission with CSI, where the PUSCH is associated with high-priority data;
   PUCCH transmission with CSI;
   PUSCH transmission without HARQ-ACK information or CSI;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or PRACH transmission on a serving cell other than the PCell.

The technique may be implemented to prioritize transmission power reduction considering both URLLC and 2-step RA, or URLL and 4-step RA. The priority order may be a combination between any one of the embodiments for the 2-step RA procedure 420 or the 4-step RA procedure 320 and any embodiment for URLLC.

One example is:
PRACH transmission on the PCell or msgA transmission on the PCell;
Transmission on the one or more cells that carry high-priority data:
   PRACH or MsgA transmission not on the PCell;
   PUCCH transmission with HARQ-ACK information and/or SR or PUSCH transmission with HARQ-ACK information, where the HARQ-ACK and/or SR is associated with high-priority data;
   PUSCH transmission with CSI, where the PUSCH is associated with high-priority data;
   PUCCH transmission with CSI;
   PUSCH transmission without HARQ-ACK information or CSI;
PUCCH transmission with HARQ-ACK information and/or SR or PUSCH transmission with HARQ-ACK information;
PUCCH transmission with CSI or PUSCH transmission with CSI;
PUSCH transmission without HARQ-ACK information or CSI;
SRS transmission, with aperiodic SRS having higher priority than semi-persistent and/or periodic SRS, or PRACH transmission on a serving cell other than the PCell, or msgA transmission on a serving cell other than the PCell and the one or more cells.

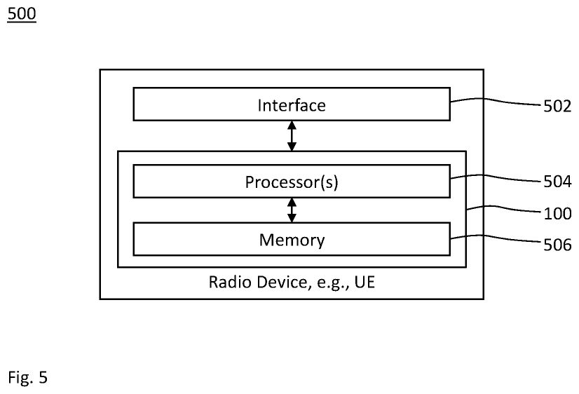

FIG. 5 shows a schematic block diagram for an embodiment of the device 100. The device 100 comprises one or more processors 504 for performing the method 200 and memory 506 coupled to the processors 504. For example, the memory 506 may be encoded with instructions that implement at least one of the modules 102 and 104.

The one or more processors 504 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 506, UL transmitter functionality. For example, the one or more processors 504 may execute instructions stored in the memory 506. Such functionality may include providing various features and steps discussed herein, including any of the benefits disclosed herein. The expression “the device being operative to perform an action” may denote the device 100 being configured to perform the action.

As schematically illustrated in FIG. 5, the device 100 may be embodied by a radio device 500, e.g., functioning as a UE. The transmitting station 500 comprises a radio interface 502 coupled to the device 100 for radio communication with one or more base stations.

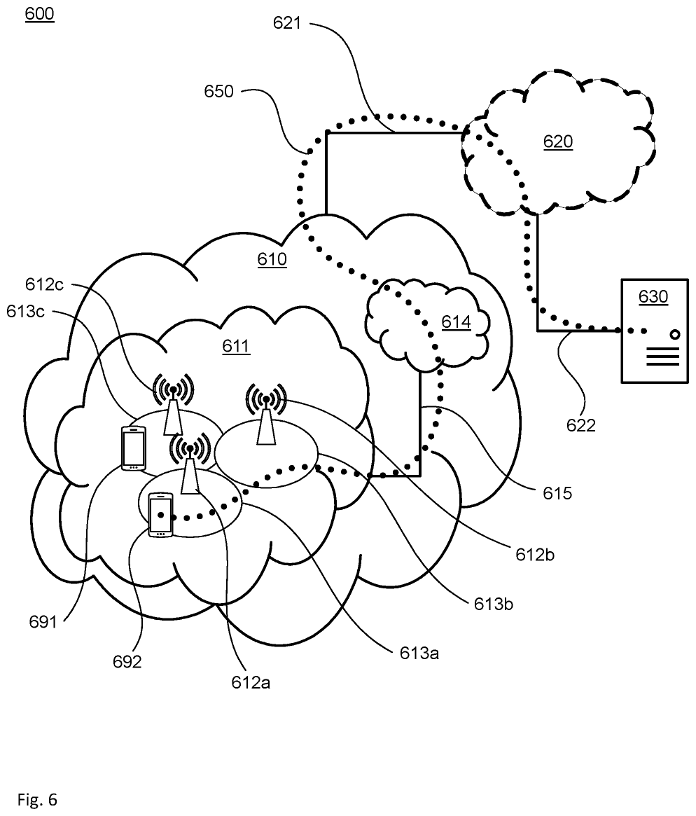

With reference to FIG. 6, in accordance with an embodiment, a communication system 600 includes a telecommunication network 610, such as a 3GPP-type cellular network, which comprises an access network 611, such as a radio access network, and a core network 614. The access network 611 comprises a plurality of base stations 612a, 612b, 612c, such as NBs, eNBs, gNBs or other types of wireless access points, each defining a corresponding coverage area 613a, 613b, 613c. Each base station 612a, 612b, 612c is connectable to the core network 614 over a wired or wireless connection 615. A first user equipment (UE) 691 located in coverage area 613c is configured to wirelessly connect to, or be paged by, the corresponding base station 612c. A second UE 692 in coverage area 613a is wirelessly connectable to the corresponding base station 612a. While a plurality of UEs 691, 692 are illustrated in this example, the disclosed embodiments are equally applicable to a situation where a sole UE is in the coverage area or where a sole UE is connecting to the corresponding base station 612.

Any of the base stations 612 and the UEs 691, 692 may embody the device 100.

The telecommunication network 610 is itself connected to a host computer 630, which may be embodied in the hardware and/or software of a standalone server, a cloud-implemented server, a distributed server or as processing resources in a server farm. The host computer 630 may be under the ownership or control of a service provider, or may be operated by the service provider or on behalf of the service provider. The connections 621, 622 between the telecommunication network 610 and the host computer 630 may extend directly from the core network 614 to the host computer 630 or may go via an optional intermediate network 620. The intermediate network 620 may be one of, or a combination of more than one of, a public, private or hosted network; the intermediate network 620, if any, may be a backbone network or the Internet; in particular, the intermediate network 620 may comprise two or more sub-networks (not shown).

The communication system 600 of FIG. 6 as a whole enables connectivity between one of the connected UEs 691, 692 and the host computer 630. The connectivity may be described as an over-the-top (OTT) connection 650. The host computer 630 and the connected UEs 691, 692 are configured to communicate data and/or signaling via the OTT connection 650, using the access network 611, the core network 614, any intermediate network 620 and possible further infrastructure (not shown) as intermediaries. The OTT connection 650 may be transparent in the sense that the participating communication devices through which the OTT connection 650 passes are unaware of routing of uplink and downlink communications. For example, a base station 612 need not be informed about the past routing of an incoming downlink communication with data originating from a host computer 630 to be forwarded (e.g., handed over) to a connected UE 691. Similarly, the base station 612 need not be aware of the future routing of an outgoing uplink communication originating from the UE 691 towards the host computer 630.

By virtue of the method 200 being performed by any one of the UEs 691 or 692 and/or any one of the base stations 612, the performance of the OTT connection 650 can be improved, e.g., in terms of increased throughput and/or reduced latency. More specifically, the host computer 630 may indicate a priority to the RAN and/or the UE 100 that is used in the priority order.

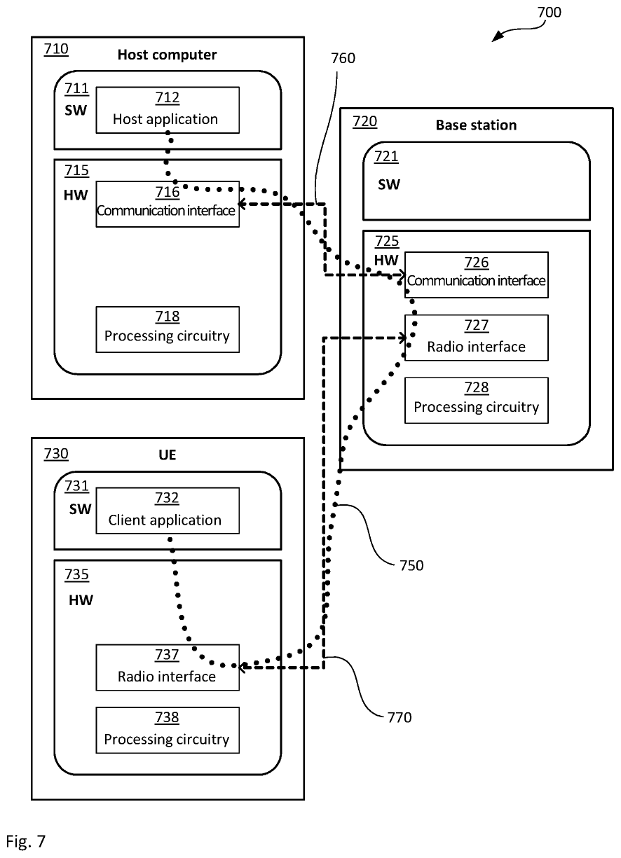

Example implementations, in accordance with an embodiment of the UE, base station and host computer discussed in the preceding paragraphs, will now be described with reference to FIG. 7. In a communication system 700, a host computer 710 comprises hardware 715 including a communication interface 716 configured to set up and maintain a wired or wireless connection with an interface of a different communication device of the communication system 700. The host computer 710 further comprises processing circuitry 718, which may have storage and/or processing capabilities. In particular, the processing circuitry 718 may comprise one or more programmable processors, application-specific integrated circuits, field programmable gate arrays or combinations of these (not shown) adapted to execute instructions. The host computer 710 further comprises software 711, which is stored in or accessible by the host computer 710 and executable by the processing circuitry 718. The software 711 includes a host application 712. The host application 712 may be operable to provide a service to a remote user, such as a UE 730 connecting via an OTT connection 750 terminating at the UE 730 and the host computer 710. In providing the service to the remote user, the host application 712 may provide user data, which is transmitted using the OTT connection 750. The user data may depend on the location of the UE 730. The user data may comprise auxiliary information or precision advertisements (also: ads) delivered to the UE 730. The location may be reported by the UE 730 to the host computer, e.g., using the OTT connection 750, and/or by the base station 720, e.g., using a connection 760.

The communication system 700 further includes a base station 720 provided in a telecommunication system and comprising hardware 725 enabling it to communicate with the host computer 710 and with the UE 730. The hardware 725 may include a communication interface 726 for setting up and maintaining a wired or wireless connection with an interface of a different communication device of the communication system 700, as well as a radio interface 727 for setting up and maintaining at least a wireless connection 770 with a UE 730 located in a coverage area (not shown in FIG. 7) served by the base station 720. The communication interface 726 may be configured to facilitate a connection 760 to the host computer 710. The connection 760 may be direct, or it may pass through a core network (not shown in FIG. 7) of the telecommunication system and/or through one or more intermediate networks outside the telecommunication system. In the embodiment shown, the hardware 725 of the base station 720 further includes processing circuitry 728, which may comprise one or more programmable processors, application-specific integrated circuits, field programmable gate arrays or combinations of these (not shown) adapted to execute instructions. The base station 720 further has software 721 stored internally or accessible via an external connection.

The communication system 700 further includes the UE 730 already referred to. Its hardware 735 may include a radio interface 737 configured to set up and maintain a wireless connection 770 with a base station serving a coverage area in which the UE 730 is currently located. The hardware 735 of the UE 730 further includes processing circuitry 738, which may comprise one or more programmable processors, application-specific integrated circuits, field programmable gate arrays or combinations of these (not shown) adapted to execute instructions. The UE 730 further comprises software 731, which is stored in or accessible by the UE 730 and executable by the processing circuitry 738. The software 731 includes a client application 732. The client application 732 may be operable to provide a service to a human or non-human user via the UE 730, with the support of the host computer 710. In the host computer 710, an executing host application 712 may communicate with the executing client application 732 via the OTT connection 750 terminating at the UE 730 and the host computer 710. In providing the service to the user, the client application 732 may receive request data from the host application 712 and provide user data in response to the request data. The OTT connection 750 may transfer both the request data and the user data. The client application 732 may interact with the user to generate the user data that it provides.

It is noted that the host computer 710, base station 720 and UE 730 illustrated in FIG. 7 may be identical to the host computer 630, one of the base stations 612a, 612b, 612c and one of the UEs 691, 692 of FIG. 6, respectively. This is to say, the inner workings of these entities may be as shown in FIG. 7, and, independently, the surrounding network topology may be that of FIG. 6.

In FIG. 7, the OTT connection 750 has been drawn abstractly to illustrate the communication between the host computer 710 and the UE 730 via the base station 720, without explicit reference to any intermediary devices and the precise routing of messages via these devices. Network infrastructure may determine the routing, which it may be configured to hide from the UE 730 or from the service provider operating the host computer 710, or both. While the OTT connection 750 is active, the network infrastructure may further take decisions by which it dynamically changes the routing (e.g., on the basis of load balancing consideration or reconfiguration of the network).

The wireless connection 770 between the UE 730 and the base station 720 is in accordance with the teachings of the embodiments described throughout this disclosure. One or more of the various embodiments improve the performance of OTT services provided to the UE 730 using the OTT connection 750, in which the wireless connection 770 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 750 between the host computer 710 and UE 730, in response to variations in the measurement results. The measurement procedure and/or the network functionality for reconfiguring the OTT connection 750 may be implemented in the software 711 of the host computer 710 or in the software 731 of the UE 730, or both. In embodiments, sensors (not shown) may be deployed in or in association with communication devices through which the OTT connection 750 passes; the sensors may participate in the measurement procedure by supplying values of the monitored quantities exemplified above, or supplying values of other physical quantities from which software 711, 731 may compute or estimate the monitored quantities. The reconfiguring of the OTT connection 750 may include message format, retransmission settings, preferred routing etc.; the reconfiguring need not affect the base station 720, and it may be unknown or imperceptible to the base station 720. Such procedures and functionalities may be known and practiced in the art. In certain embodiments, measurements may involve proprietary UE signaling facilitating the host computer's 710 measurements of throughput, propagation times, latency and the like. The measurements may be implemented in that the software 711, 731 causes messages to be transmitted, in particular empty or “dummy” messages, using the OTT connection 750 while it monitors propagation times, errors etc.

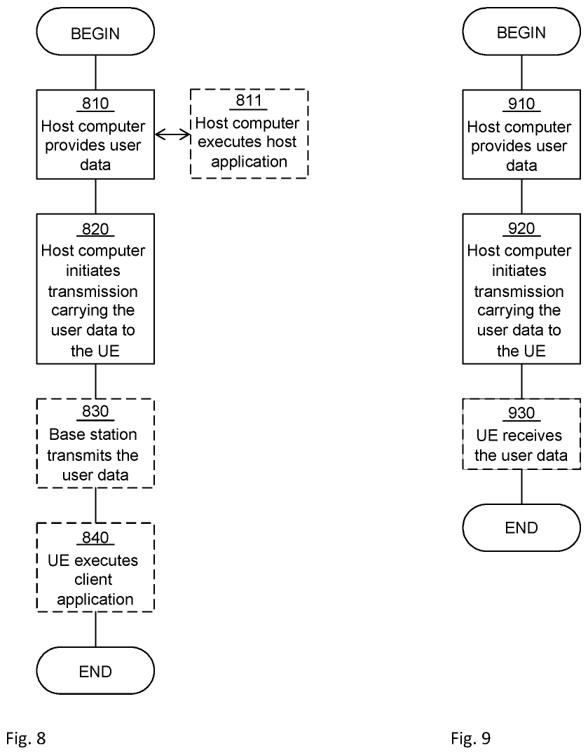

FIG. 8 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 8 will be included in this paragraph. In a first step 810 of the method, the host computer provides user data. In an optional substep 811 of the first step 810, the host computer provides the user data by executing a host application. In a second step 820, the host computer initiates a transmission carrying the user data to the UE. In an optional third step 830, the base station transmits to the UE the user data which was carried in the transmission that the host computer initiated, in accordance with the teachings of the embodiments described throughout this disclosure. In an optional fourth step 840, the UE executes a client application associated with the host application executed by the host computer.

FIG. 9 is a flowchart illustrating a method implemented in a communication system, in accordance with one embodiment. The communication system includes a host computer, a base station and a UE which may be those described with reference to FIGS. 6 and 7. For simplicity of the present disclosure, only drawing references to FIG. 9 will be included in this paragraph. In a first step 910 of the method, the host computer provides user data. In an optional substep (not shown) the host computer provides the user data by executing a host application. In a second step 920, the host computer initiates a transmission carrying the user data to the UE. The transmission may pass via the base station, in accordance with the teachings of the embodiments described throughout this disclosure. In an optional third step 930, the UE receives the user data carried in the transmission.

In any embodiment, the method 200 may determine the priority of power reductions with respect to channels used in a 2-step RA and/or a 4-step RA and/or for a URLLC.

As has become apparent from above description, embodiments of the technique allow for improved prioritizing the channels targeting for low latency and more reliable services, e.g. a msgA in a 2-step RA procedure and/or channels for transmission of the prioritized data transmission.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention may be limited (e.g., only) by the scope of the following claims.

1-52. (canceled)

53. A method of allocating transmit power for at least two uplink (UL) transmissions on one or more cells of a radio access network (RAN), the method comprising:
allocating the transmit power for the UL transmissions, such that a total transmit power resulting from the allocation is less than or equal to a maximum transmit power, by allocating the transmit power to the UL transmissions according to a priority order of the UL transmissions;
wherein at least one UL transmission of a low-latency communication is prioritized over at least one UL transmission of a regular communication according to the priority order.

54. The method of claim 53:
wherein the at least one UL transmission of the low-latency communication comprises the UL transmission on a physical uplink shared channel (PUSCH) in a 2-step Random Access (RA) procedure on a primary cell (PCell);
wherein the UL transmission on the PUSCH in the 2-step RA procedure on the PCell is prioritized according to the priority order over at least one of the UL transmission of the RA preamble in the 2-step RA procedure on the PCell and the UL transmission of a RA preamble in a 4-step RA procedure on the PCell.

55. The method of claim 54, wherein the UL transmission of a RA preamble in a 4-step RA procedure on the PCell and the UL transmission of the RA preamble in the 2-step RA procedure on the PCell have the same priority according to the priority order.

56. The method of claim 54, wherein the UL transmission of a RA preamble in a 4-step RA procedure on the PCell is prioritized according to the priority order over the UL transmission in the 2-step RA procedure on the PCell.

57. The method of claim 54, wherein the UL transmission of a RA preamble in a 2-step RA procedure on the PCell is prioritized according to the priority order over the UL transmission of the RA preamble in the 4 step RA procedure on the PCell.

58. The method of claim 54, wherein the UL transmission in the 2-step RA procedure on the PCell is prioritized according to the priority order over the UL transmission in the 2-step RA procedure on a serving cell other than the PCell.

59. The method of claim 53, wherein the regular communication comprises a 2-step Random Access (RA) procedure on a serving cell other than a primary cell (PCell).

60. The method of claim 53, wherein the at least one UL transmission of the regular communication comprises the UL transmission of a Random Access (RA) preamble in a 2-step RA procedure on a serving cell other than a primary cell (PCell).

61. The method of claim 53, wherein the at least one UL transmission of the regular communication comprises the UL transmission on a physical uplink shared channel (PUSCH) in a 2-step Random Access (RA) procedure on a serving cell other than a primary cell (PCell).

62. The method of claim 61, wherein a PUSCH part of a 2-step RA procedure for a PCell and other serving cells has the same priority as normal PUSCH.

63. The method of claim 53, wherein the at least one UL transmission of the regular communication comprises the UL transmission of a Random Access (RA) preamble in a 4-step RA procedure on a serving cell other than the PCell.

64. The method of claim 54:
wherein the at least one UL transmission of the regular communication comprises the UL transmission of a RA preamble in a 2-step RA procedure on a serving cell other than a PCell;
wherein the at least one UL transmission of the regular communication comprises the UL transmission of a sounding reference signal (SRS);
wherein at least two of the UL transmission of the SRS, the UL transmission of the RA preamble in the 4 step RA procedure on the serving cell other than the PCell, and the UL transmission of the RA preamble in the 2-step RA procedure on the serving cell other than the PCell have the same priority according to the priority order.

65. The method of claim 64, wherein at least one of the UL transmission on the PUCCH, the UL transmission of payload on the PUSCH without a control message, the UL transmission of the SRS, and the UL transmission of the RA preamble in the 4-step RA procedure on the serving cell other than the PCell is prioritized according to the priority order over the UL transmission in the 2-step RA procedure on the serving cell other than the PCell.

66. The method of claim 54:
wherein the at least one UL transmission of the low-latency communication comprises an initial transmission on a PUSCH in a 2-step RA procedure on the PCell; and
wherein the at least one UL transmission of the regular communication comprises a retransmission on the PUSCH in the 2-step RA procedure on the PCell.

67. The method of claim 54:
wherein a PUSCH part of a 2-step RA procedure for an initial transmission has a higher priority than at least one of a physical uplink control channel (PUCCH), PUSCH, sounding reference signal (SRS); and
wherein a retransmission of the PUSCH part of the 2-step RA procedure has the same priority as normal PUSCH.

68. The method of claim 54, wherein at least one of the UL transmission in the 2-step RA procedure on the PCell and the UL transmission of a RA preamble in a 4-step RA procedure on the PCell is prioritized according to the priority order over at least one of the UL transmission in the 2-step RA procedure of a ultra-reliable low-latency communication (URLLC) and the UL transmission of the RA preamble in the 4-step RA procedure of the URLLC.

69. The method of claim 53:
wherein the total transmit power resulting from the allocation is less than or equal to the maximum transmit power by allocating a second transmit power to at least one of the UL transmissions having a second priority;
wherein the second transmit power is reduced relative to a predefined transmit power or a first transmit power allocated to another one of the UL transmissions having a first priority that is higher than the second priority according to the priority order.

70. The method of claim 69, further comprising:
determining the total transmit power in a symbol of a transmission occasion;
wherein the allocation comprises reducing the second transmit power if the determined total transmit power would exceed the total transmit power.

71. The method of claim 53:
wherein the maximum transmit power is a linear value of a maximum output power in a transmission occasion; and
wherein the total transmit power in each symbol of the transmission occasion is the sum of the linear values of the transmit powers allocated to the UL transmissions in the respective symbol.

72. A device for allocating transmit power for at least two uplink (UL) transmissions on one or more cells of a radio access network (RAN), the device comprising:
processing circuitry;
memory containing instructions executable by the processing circuitry whereby the device is operative to:
allocate the transmit power for the UL transmissions, wherein a total transmit power resulting from the allocation is less than or equal to a maximum transmit power by allocating the transmit power to the UL transmissions according to a priority order of the UL transmissions;
wherein at least one UL transmission of a low-latency communication is prioritized over at least one UL transmission of regular communication according to the priority order.
